(19) United States
(12) Patent Application Publication
(10) Pub. No.: US 2014/0013238 A1
(43) Pub. Date: Jan. 9, 2014

(54) FILE TRANSFER METHOD AND DEVICE

(71) Applicant: BEIJING XIAOMI Technology CO., LTD., Beijing (CN)

(72) Inventors: Fan JIN, Beijing (CN); Tao Peng, Beijing (CN); Le Cui, Beijing (CN)

(21) Appl. No.: 13/930,794

(22) Filed: Jun. 28, 2013

(30) Foreign Application Priority Data
Jul. 5, 2012 (CN) CN201210232007.7

(51) Int. Cl. H04L 29/08

(52) U.S. Cl. CPC H04L 67/06
USPC 715/748

(57) ABSTRACT

A file transfer method for use in a mobile terminal, including: obtaining a file specification corresponding to a first file stored in a network disk; and displaying the obtained file specification in a local gateway interface of the mobile terminal, the gateway interface being located in a same display interface as a file interface of the mobile terminal for display of locally stored files.

### RELATED APPLICATIONS

This application is based upon and claims the benefit of priority from Chinese Patent Application No. CN201210232007.7, filed Jul. 5, 2012, the entire contents of which are incorporated herein by reference.

### TECHNICAL FIELD

This disclosure generally relates to communication technology, particularly to a file transfer method and device.

### BACKGROUND

A network disk is an online storage provided by network companies. The network disk may be considered as a hard disk or U disk placed in a network. Therefore, the network disk is also called a network U disk or network hard disk. The network disk is used for providing users with online file management functions such as storage, access, backup, and sharing. Through the network disk, a user can manage files stored on line in the network disk through a mobile terminal in any place where the network is accessible.

FIG. 1A illustrates a flowchart of a conventional method 100 for the mobile terminal to upload a locally stored file to the network disk. Referring to FIG. 1A, in step S101, the user runs network application software installed on the mobile terminal. In step S102, the network application software establishes a connection with the network, obtains a file specification corresponding to the file to be stored on line in the network disk, and displays the obtained file specification on the mobile terminal. FIG. 1B illustrates a diagram of a process in which the mobile terminal uses the method 100 (FIG. 1A) to upload the locally stored file to the network disk.

Referring to FIGS. 1A and 1B, after the mobile terminal runs the network application software, information regarding the file specification of the online stored file in the network disk is displayed in an online storage interface 110 of the network application software for the user to look up.

In step S103, the user clicks a file upload button 114 in the online storage interface 110. As a result, the network application software starts a local file manager of the mobile terminal. The local file manager displays a file interface 112.

Specifically, the file upload button 114 is provided in the online storage interface 110 of the network application software. After the user clicks this file upload button 114, the network disk application software starts the local file manager of the mobile terminal and the local file manager displays the file interface 112. The file interface 112 provides files stored in each local path of the mobile terminal for the user to select to be uploaded.

In step S104, the user selects a file to be uploaded and clicks an upload button 116 in the file interface 112. The network application software then turns off the local file manager and uploads the file selected by the user to the network disk.

Specifically, the upload button 116 is provided in the file interface 112. After selecting the file to be uploaded, the user clicks this upload button 116. The network application software turns off the local file manager and uploads the file selected by the user to the network disk.

FIG. 2A illustrates a flowchart of a conventional method 200 for the mobile terminal to download a file stored on line in the network disk to a local medium. Referring to FIG. 2A, in step S201, the user runs the network application software installed on the mobile terminal. In step S202, the network application software establishes a connection with the network, obtains file specifications corresponding to respective files stored on line in the network disk, and displays the file specifications. FIG. 2B illustrates a diagram of a process in which the mobile terminal uses the method 200 (FIG. 2A) to download a file stored on line in the network disk to the local medium.

Referring to FIGS. 2A and 2B, after the mobile terminal runs the network disk application software, information regarding the file specifications of the online stored files in the network disk is displayed in an online storage interface 210 of the network application software for the user to look up and to select the file to be downloaded.

In step S203, the user selects the file specification corresponding to the file to be downloaded and clicks a download button 214 in the online storage interface 210. As a result, the network application software starts the local file manager of the mobile terminal. The local file manager displays a file interface 212 on the mobile terminal.

Specifically, the download button 214 is provided in the online storage interface 210 of the network application software. The user can select the file specification corresponding to the file to be downloaded and clicks the download button 214. Then the network application software starts the local file manager of the mobile terminal and the local file manager displays the file interface 212. The file interface 212 provides each local path of the mobile terminal for the user to select a path for storing the file to be downloaded.

In step S204, the user specifies the path for storing the file to be downloaded and clicks a download button 216 in the file interface 212. The network application software then turns off the local file manager and downloads the file corresponding to the file specification selected by the user into the path specified by the user.

### SUMMARY

According to a first aspect of the present disclosure, there is provided a file transfer method for use in a mobile terminal, comprising: obtaining a file specification corresponding to a first file stored in a network disk; and displaying the obtained file specification in a local gateway interface of the mobile terminal, the gateway interface being located in a same display interface as a file interface of the mobile terminal for display of locally stored files.

According to a second aspect of the present disclosure, there is provided a mobile terminal, comprising: a processor; and a memory including executable instructions; wherein the processor is configured to: obtain a file specification corresponding to a first file stored in a network disk; and display the obtained file specification in a local gateway interface, the gateway interface being located in a same display interface as a file interface used for display of locally stored files.

According to a third aspect of the present disclosure, there is provided a non-transitory medium including instructions, executable by a processor in a mobile terminal, for performing a file transfer method, the method comprising: obtaining a file specification corresponding to a first file stored in a network disk; and displaying the obtained file specification in a local gateway interface of the mobile terminal, the gateway interface being located in a same display interface as a file interface of the mobile terminal for display of locally stored files.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain principles of the invention.

FIG. 1A illustrates a flowchart of a conventional method for a mobile terminal to upload a locally stored file to a network disk.

FIG. 1B illustrates a diagram of a process in which a mobile terminal uses the method illustrated in FIG. 1A to upload a locally stored file to a network disk.

FIG. 2A illustrates a flowchart of a conventional method for a mobile terminal to download a file stored on line in a network disk to a local medium.

FIG. 2B illustrates a diagram of a process in which the mobile terminal uses the method illustrated in FIG. 2A to download a file stored on line in a network disk.

FIG. 3 illustrates a flowchart of a file transfer method for use in a mobile terminal, according to an exemplary embodiment.

FIG. 4A illustrates a method for a mobile terminal to display a gateway interface and a file interface, according to an exemplary embodiment.

FIG. 4B illustrates a method for a mobile terminal to display a gateway interface and a file interface, according to an exemplary embodiment.

FIG. 5 illustrates a diagram of a process in which a mobile terminal uploads a locally stored file to a network disk, according to an exemplary embodiment.

FIG. 6 illustrates a diagram of a process in which a mobile terminal downloads a file stored in a network disk to a local medium, according to an exemplary embodiment.

FIG. 7 illustrates a block diagram of a file transfer apparatus, according to an exemplary embodiment.

FIG. 8 illustrates a block diagram of a file transfer system, according to an exemplary embodiment.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention, Instead, they are merely examples of systems and methods consistent with aspects related to the invention as recited in the appended claims.

In exemplary embodiments, there is provided a file transfer method in which a local gateway interface is arranged in a local file manager of a mobile terminal. This gateway interface is configured to display file specifications corresponding to respective files stored in a network disk and is located in the same display interface as a file interface used for display of locally stored files. In this way, when there is a need for file transfer with the network disk, the mobile terminal needs only to start the local file manager without switching the current display interface.

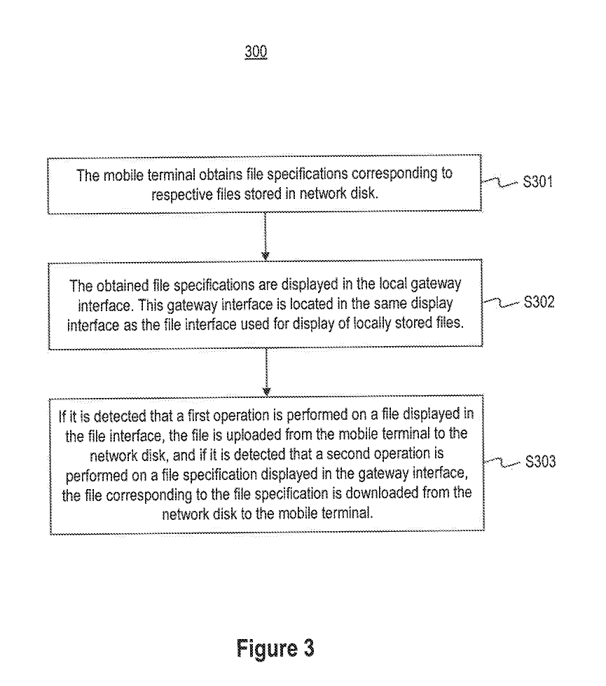

FIG. 3 illustrates a flowchart of a file transfer method 300 for use in the mobile terminal, according to an exemplary embodiment. Referring to FIG. 3, the method 300 includes the following steps.

In step S301, the mobile terminal obtains file specifications corresponding to respective files stored in network disk. Specifically, the mobile terminal first establishes a communication connection with the network disk, and when the communication connection between the mobile terminal and the network disk is established, the file specifications corresponding to the respective files stored in the network disk are obtained. For example, the obtained file specifications may include names and types of the corresponding files stored in the network disk.

In step S302, the file specifications are displayed in the local gateway interface of the mobile terminal. The gateway interface is located in the same display interface as the file interface used for display of locally stored files. Specifically, the gateway interface may be arranged in the local file manager of the mobile terminal. The gateway interface is configured to display the obtained file specifications corresponding to the respective files stored in the network disk.

In step S303, if it is detected that a first operation is performed on a file displayed in the file interface, the file is uploaded from the mobile terminal to the network disk, and if it is detected that a second operation is performed on a file specification displayed in the gateway interface, the file corresponding to the file specification is downloaded from the network disk to the mobile terminal. Specifically, a user of the mobile terminal may perform an operation on the file specification displayed in the gateway interface or the file displayed in the file interface. The mobile terminal implements file transfer with the network disk based on the user's operation, as described below.

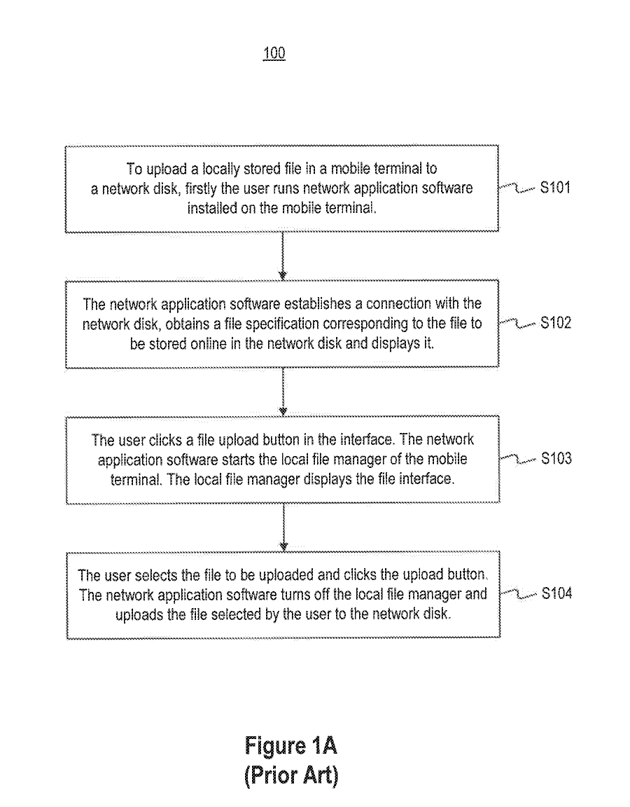

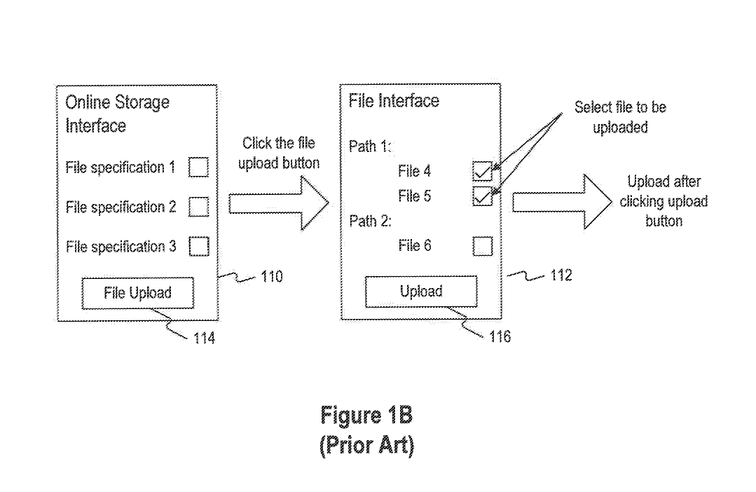

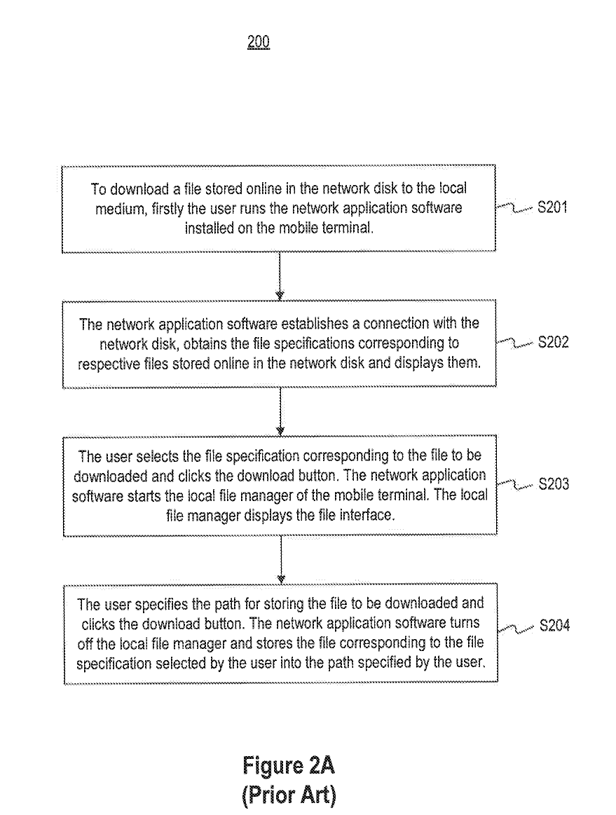

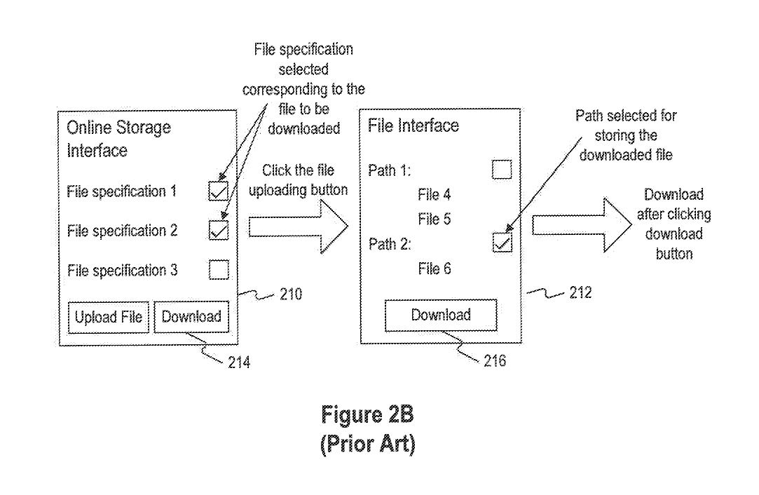

In the method 300, because the gateway interface for displaying the file specifications corresponding to the files stored in the network disk is arranged in the local file manager of the mobile terminal and is located in the same display interface as the file interface used for display of locally stored files, the mobile terminal does not need to switch the current display interface frequently due to frequent turning-on and turning-off of the local file manager, as practiced by the network application software in the conventional file transfer methods 100 (FIG. 1A) and 200 (FIG. 2A). As a result, the file transfer process between a mobile terminal and a network disk may be simplified and file transfer efficiency may be improved.

Further, when the local file manager of the mobile terminal displays the gateway interface and the file interface in the same display interface, these two interfaces may be displayed at the same time. Alternatively, a tag may be used for displaying each of he two interfaces based on the user's operation on the tag, as described below.

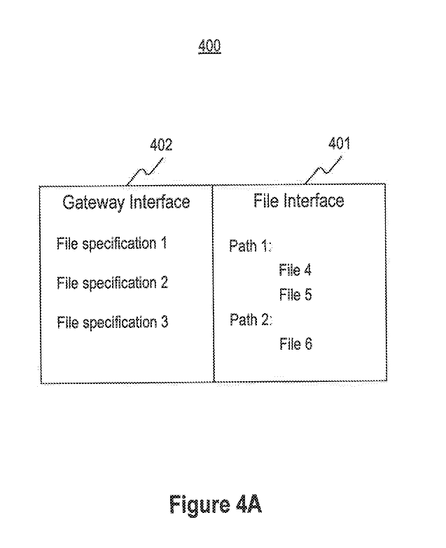

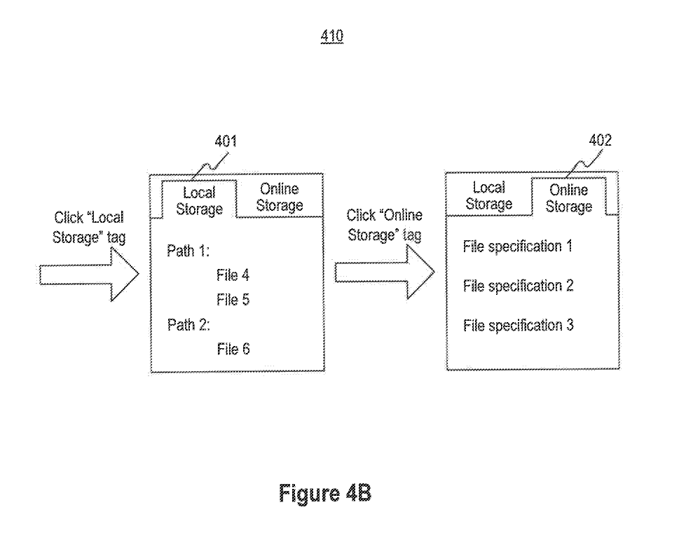

FIG. 4A illustrates a method 400 for the mobile terminal to display a file interface 401 and a gateway interface 402, according to an exemplary embodiment, Referring to FIG. 4A, the mobile terminal displays and, hence, provides to the user the gateway interface 402 and the file interface 401 at the same time in the same display interface. The file interface 401 provides the files stored by the mobile terminal in each local path. The gateway interface 402 provides the file specifications of the respective files stored in the network disk.

FIG. 4B illustrates a method 410 for the mobile terminal to display the gateway interface 402 and the file interface 401, according to an exemplary embodiment. Referring to FIG. 4B, a tag labeled as “Local Storage” is set for the file interface 401, and a tag labeled as “Online Storage” is set for the gateway interface 402. When the user clicks the “Local Storage” tag, the mobile terminal displays the file interface 401. When the user clicks the “Online Storage” tag, the mobile terminal displays the gateway interface 402. That is, as shown in FIG. 4B, the gateway interface 402 and the file interface 401 are located in the same display interface and are available to the user at the same time.

As described above with respect to FIG. 3, the mobile terminal implements file transfer with the network disk on the basis of the detected operation on the file specification displayed in the gateway interface 402 and the file displayed in the file interface 401. In exemplary embodiments, different methods may be used by the mobile terminal to implement file transfer with the network disk on the basis of the detected operation.

In one exemplary embodiment, to upload a locally stored file from the mobile terminal to the network disk, the user can copy the corresponding file in the file interface 401 and paste it to the gateway interface 402. Specifically, the mobile terminal uploads the file to the network disk in response to detecting the operation of copying the file displayed in the file interface 401 and pasting it to the gateway interface 402.

In one exemplary embodiment, to upload a locally stored file to the network disk, the user can cut the corresponding file in the file interface 401 and paste it to the gateway interface 402. Specifically, the mobile terminal uploads the file to the network disk in response to detecting the operation of cutting the file displayed in the file interface 401 and pasting it to the gateway interface 402, and further deletes the file from the mobile terminal.

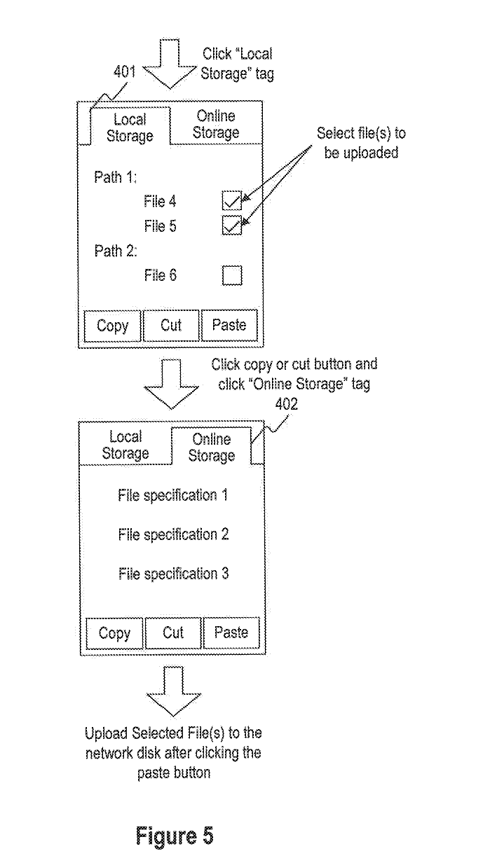

FIG. 5 illustrates a diagram of a process 500 in which the mobile terminal uploads a locally stored file to the network disk based on the method 410 (FIG. 4B), according to an exemplary embodiment. Referring to FIG. 5, the mobile terminal provides with a copy button, a cut button, and a paste button in each of the file interface 401 and the gateway interface 402. To upload the file to the network disk, the user can firstly click the “Local Storage” tag and, in response, the mobile terminal displays the file interface 401. After selecting in the file interface 401 the file in a file path to be uploaded to the network disk, the user can click the copy button or the cut button as needed. The mobile terminal caches the file to be copied or cut. Then the user can click the “Online Storage” tag and, in response, the mobile terminal displays the gateway interface 402. After the user clicks this paste button, the mobile terminal pastes the cached file into the gateway interface 402 and uploads the pasted file to the network disk. That is, when the user selects the file in the file interface 401, clicks the copy or cut button in the file interface 401, and then clicks the paste button in the gateway interface 402, the mobile terminal determines having detected the operation of copying or cutting the selected file to the gateway interface 402 and, in response, pastes the file into the gateway interface 402 and uploads the pasted file to the network disk.

In one exemplary embodiment, when the mobile terminal displays the gateway interface 402 and the file interface 401 in the same display interface at the same time, as shown in FIG. 4A, the mobile terminal may determine having detected the operation of copying or cutting the file displayed in the file interface 401 to the gateway interface 402 when detecting the operation of dragging the file displayed in the file interface 401 to the gateway interface 402.

In one exemplary embodiment, to download a file stored in the network disk to the local medium in the mobile terminal, the user can copy the file specification corresponding to the file displayed in the gateway interface 402 and paste it to the file interface 401. Specifically, the mobile terminal downloads the file corresponding to the file specification from the network disk in response to detecting the operation of copying the file specification displayed in the gateway interface 402 and pasting it to the file interface 401. In addition, after downloading the file to the local medium, the mobile terminal also replaces the corresponding file specification copied to the file interface 401 with the file downloaded.

In one exemplary embodiment, to download a file stored in the network disk to the local medium in the mobile terminal, the user can cut the file specification corresponding to the file to be downloaded that is displayed in the gateway interface 402 and paste it to the file interface 401. Specifically, the mobile terminal downloads the file corresponding to the file specification from the network disk in response to detecting the operation of cutting the file specification displayed in the gateway interface 402 and pasting it to the file interface 401. In addition, after downloading the file to the local medium, the mobile terminal also replaces the corresponding file specification copied to the file interface 401 with the file downloaded.

In exemplary embodiments, after obtaining the file specification corresponding to the file stored in network disk, the mobile terminal may also establish a corresponding relationship between a storage path of the file stored in the network disk and the obtained file specification corresponding to this file. The mobile terminal may determine the storage path corresponding to the file specification, and then download the file from the network disk according to the determined storage path.

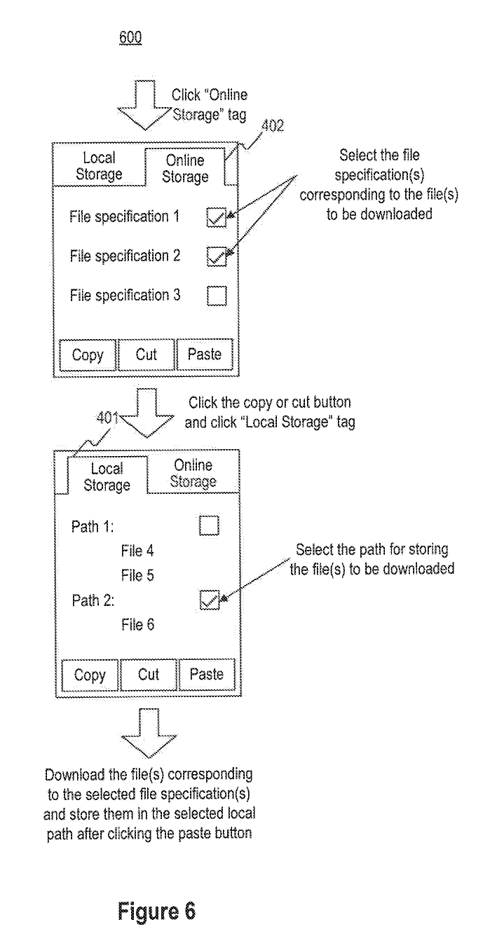

FIG. 6 illustrates a diagram of a process 600 in which the mobile terminal downloads a file stored in the network disk to the local medium based on the method 410 (FIG. 4B), according to an exemplary embodiment. Referring to FIG. 6, the mobile terminal provides a copy button, a cut button, and a paste button in each of the gateway interface 402 and the file interface 401. To download a file from the network disk, the user can firstly click the “Online Storage” tag and, in response, the mobile terminal displays the gateway interface 402. After selecting the file specification corresponding to the file in the gateway interface 402 to be downloaded to the local medium in the mobile terminal, the user can click the copy button or the cut button as needed. The mobile terminal firstly caches the file specification to be copied or cut. Then the user can click the “Local Storage” tag and, in response, the mobile terminal displays the file interface 401. After the user selects the path for storing the file to be downloaded in the file interface 401 and clicks the paste button, the mobile terminal pastes the cached file specification into the file interface 401 in the selected path, downloads the file corresponding to the pasted file specification from the network disk, and stores the downloaded file in the selected path. After the file is downloaded, the file specification pasted in the file interface 401 is replaced with the file downloaded.

In exemplary embodiments, other operations may also be implemented through the file specification displayed in the gateway interface 402 to realize additional management operations on a file stored in the network disk. For example, the user can delete the file specification in the gateway interface 402 directly. When the mobile terminal detects the operation of deleting the file specification displayed in the gateway interface 402, the mobile terminal directs the network disk to delete the file corresponding to this file specification.

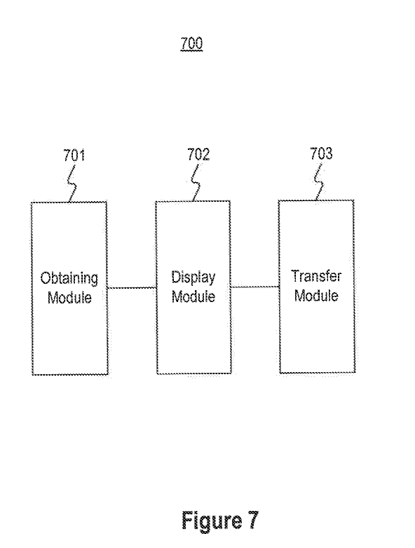

FIG. 7 illustrates a block diagram of a file transfer apparatus 700, according to an exemplary embodiment. For example, the apparatus 700 may be included in the above-noted mobile terminal. Referring to FIG. 7, the apparatus 700 includes an obtaining module 701, a display module 702, and a transfer module 703.

In exemplary embodiments, the obtaining module 701 is configured to obtain the file specifications corresponding to respective files stored in the network disk. The display module 702 is configured to display the obtained file specifications in the gateway interface. The gateway interface is located in the same display interface as the file interface used for display of locally stored files. The transfer module 703 is configured to upload a file displayed in the file interface to the network disk when it is detected that a first operation is performed on the file, and to download a file corresponding to the file specification displayed in the gateway interface from the network disk when it is detected that a second operation is performed on the file specification.

Specifically, the obtaining module 701 is configured to obtain the file specifications corresponding to respective files stored in network disk when the mobile terminal establishes a communication connection with the network disk. The transfer module 703 is configured to upload the file displayed in the file interface to the network disk when the operation of copying the file displayed in the file interface to the gateway interface is detected, or to upload the file to the network disk and delete this locally stored file when the operation of cutting the file displayed in the file interface to the gateway interface is detected. The transfer module 703 is configured to download the file specification from the network disk when the operation of copying the file specification displayed in the gateway interface to the file interface is detected, or to download the file specification from the network disk and delete the file when the operation of cutting the file specification displayed in the gateway interface to the file interface is detected.

In exemplary embodiments, the obtaining module 701 is also configured to establish a corresponding relationship between the storage path of the file stored in the network disk and the obtained file specification corresponding to this file after obtaining the file specification. The transfer module 703 is configured to determine the storage path corresponding to the file specification and to download the file from the network disk in accordance with the determined storage path.

In exemplary embodiments, each of the obtaining module 701, the display module 702, and the transfer module 703 may be hardware, software, or some combination of hardware and software.

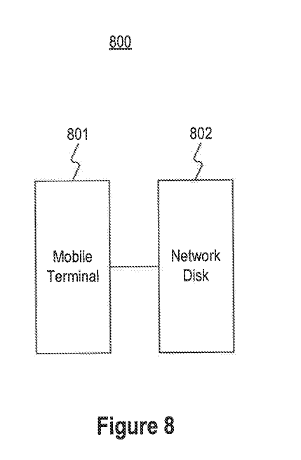

FIG. 8 illustrates a block diagram of a file transfer system 800, according to an exemplary embodiment. The system 800 includes a mobile terminal 801 and a network disk 802.

Referring to FIG. 8, in exemplary embodiments, the mobile terminal 801 is configured to obtain the file specifications corresponding to respective files stored in the network disk 802 and display the obtained file specifications in the gateway interface. The gateway interface is located in the same display interface as the file interface used for display of locally stored files. When it is detected that a first operation is performed on the file displayed in the file interface, the mobile terminal 801 uploads the file to the network disk 802. When it is detected that a second operation is performed on a file specification displayed in the gateway interface, the mobile terminal 801 downloads the file corresponding to the file specification from the network disk 802. The network disk 802 is configured to provide the mobile terminal 801 with the file specifications corresponding to the respective stored files, to receive and store the file uploaded by the mobile terminal 801, and to provide the mobile terminal 801 with the file to be downloaded.

In exemplary embodiments, the mobile terminal 801 carries out respective uploading or downloading in accordance with detected operations on the file displayed in the file interface or on the file specification displayed in the gateway interface. Because the gateway interface used for display of the file specification corresponding to the file stored in network disk 802 is located in the same display interface as the file interface used for display of locally stored file, the mobile terminal 801 does not need to switch the display interface frequently, which simplifies the file transfer process between the mobile terminal 801 and the network disk 802 and improves file transfer efficiency.

In exemplary embodiments, the mobile terminal 801 may include one or more of the following components: a processor configured to execute computer program instructions to perform various processes and methods, random access memory (RAM) and read only memory (ROM) configured to access and store information and computer program instructions, storage to store data and information, databases to store tables, lists, or other data structures, I/O devices, interfaces, antennas, etc.

One of ordinary skill in the art can make various changes and modifications to this invention without breaking away from the spirit or scope of this invention. Therefore, if such changes and modifications to this invention belong to the scope of the claim of this invention or of the equivalent technologies, this invention also intends to include such changes and modifications.

Other embodiments of the invention will be apparent to those skilled in the art from consideration of the specification and practice of the embodiments disclosed herein. The scope of the invention is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A file transfer method for use in a mobile terminal, comprising:
obtaining a file specification corresponding to a first file stored in a network disk; and
displaying the obtained file specification in a local gateway interface of the mobile terminal, the gateway interface being located in a same display interface as a file interface of the mobile terminal for display of locally stored files.

2. The method of claim 1, further comprising:
when it is detected that a first operation is performed on the file specification displayed in the gateway interface, downloading the first file corresponding to the file specification from the network disk; and
when it is detected that a second operation is performed on a second file displayed in the file interface, uploading the second file to the network disk.

3. The method of claim 1, wherein obtaining the file specification comprises:
obtaining the file specification when the mobile terminal establishes a communication connection with the network disk.

4. The method of claim 2, wherein uploading the second file to the network disk comprises:
detecting an operation of copying the second file displayed in the file interface and pasting the second file to the gateway interface; and
uploading, in response to the detecting, the second file to the network disk.

5. The method of claim 2, wherein uploading the second file to the network disk comprises:
detecting an operation of cutting the second file displayed in the file interface and pasting the second file to the gateway interface, and
in response to the detecting, uploading the second file to the network disk and deleting the second file from the mobile terminal.

6. The method of claim 2, wherein downloading the first e corresponding to the file specification from the network disk comprises:
detecting an operation of copying the file specification displayed in the gateway interface and pasting the file specification to the file interface; and
downloading, in response to the detecting, the first file corresponding to the file specification from the network disk.

7. The method of claim 2, wherein downloading the first file corresponding to the file specification from the network disk comprises:
detecting an operation of cutting the file specification displayed in the gateway interface and pasting the file specification to the file interface; and
in response to the detecting, downloading the first file corresponding to the file specification from the network disk and deleting the first file from the network disk.

8. The method of claim 2, wherein the mobile terminal establishes a corresponding relationship between a storage path of the first file stored in the network disk and the obtained file specification, the downloading of the first file comprising:
determining the storage path corresponding to the file specification; and
downloading the first file from the network disk in accordance with the determined storage path.

9. A mobile terminal, comprising:
a processor; and
a memory including executable instructions;
wherein the processor is configured to:
obtain a file specification corresponding to a first file stored in a network disk; and
display the obtained file specification in a local gateway interface, the gateway interface being located in a same display interface as a file interface used for display of locally stored files.

10. The mobile terminal of claim 9, wherein the processor is further configured to:
download the first file corresponding to the file specification from the network disk when it is detected that a first operation is performed on the file specification displayed in the gateway interface; and
upload a second file displayed in the file interface to the network disk when it is detected that a second operation is performed on the second file.

11. The mobile terminal of claim 9, wherein the processor is further configured to obtain the file specification corresponding to the first file stored in network disk when the mobile terminal establishes a communication connection with the network disk.

12. The mobile terminal of claim 10, wherein the processor is further configured to upload the second file to the network disk, in response to detecting an operation of copying the second file displayed in the file interface and pasting the second file to the gateway interface.

13. The mobile terminal of claim 10, wherein the processor is further configured to upload the second file to the network disk and delete the second file from the mobile terminal, in response to detecting an operation of cutting the second file displayed in the file interface and pasting the second file to the gateway interface.

14. The mobile terminal of claim 10, wherein the processor is further configured to download the first file corresponding to the file specification from the network disk, in response to detecting an operation of copying the file specification displayed in the gateway interface and pasting the file specification to the file interface.

15. The mobile terminal of claim 10, wherein the processor is further configured to download the first file corresponding to the file specification from the network disk and delete the first file from the network disk, in response to detecting an operation of cutting the file specification displayed in the gateway interface and pasting the file specification to the file interface.

16. The mobile terminal of claim 10, wherein the processor is further configured to:
establish a corresponding relationship between a storage path of the first file stored in the network disk and the obtained file specification; and
determine the storage path corresponding to the file specification and download the first file from the network disk in accordance with the determined storage path.

17. A non-transitory medium including instructions, executable by a processor in a mobile terminal, for performing a file transfer method, the method comprising:
obtaining a file specification corresponding to a first file stored in a network disk; and
displaying the obtained file specification in a local gateway interface of the mobile terminal, the gateway interface being located in a same display interface as a file interface of the mobile terminal for display of locally stored files.

18. The non-transitory medium of claim 17, wherein the method further comprises:
when it is detected that a first operation is performed on the file specification displayed in the gateway interface, downloading the first file corresponding to the file specification from the network disk; and
when it is detected that a second operation is performed on a second file displayed in the file interface, uploading the second file to the network disk.

19. The non-transitory medium of claim 17, wherein obtaining the file specification comprises:
obtaining the file specification when the mobile terminal establishes a communication connection with the network disk.

20. The non-transitory medium of claim 18, wherein uploading the second file to the network disk comprises:
detecting an operation of copying the second file displayed in the file interface and pasting the second file to the gateway interface; and
uploading, in response to the detecting, the second file to the network disk.

21. The non-transitory medium of claim 18, wherein uploading the second file to the network disk comprises:
detecting an operation of cutting the second file displayed in the file interface and pasting the second file to the gateway interface, and
in response to the detecting, uploading the second file to the network disk and deleting the second file from the mobile terminal.

22. The non-transitory medium of claim 18, wherein downloading the first file corresponding to the file specification from the network disk comprises:
detecting an operation of copying the file specification displayed in the gateway interface and pasting the file specification to the file interface; and
downloading, in response to the detecting, the first file corresponding to the file specification from the network disk.

23. The non-transitory medium of claim 18, wherein downloading the first file corresponding to the file specification from the network disk comprises:
detecting an operation of cutting the file specification displayed in the gateway interface and pasting the file specification to the file interface; and
in response to the detecting, downloading the first file corresponding to the file specification from the network disk and deleting the first file from the network disk.

24. The non-transitory medium of claim 18, wherein the mobile terminal establishes a corresponding relationship between a storage path of the first file stored in the network disk and the obtained file specification, the downloading of the first file comprising:
determining the storage path corresponding to the file specification; and
downloading the first file from the network disk in accordance with the determined storage path.
